(19) United States
(12) Patent Application Publication
(10) Pub. No.: US 2003/0043191 A1
(43) Pub. Date: Mar. 6, 2003

(54) Systems and methods for displaying a graphical user interface

(76) Inventors: David Tinsley, Campbell, CA (US); Frederick Joseph Patton II, San Jose, CA (US)

Correspondence Address: Law Office of Bao Tran, 3103 Glen Alto Court, San Jose, CA, 95148, US

(21) Appl. No.: 09/932,217

(22) Filed: Aug. 17, 2001

(51) Int. Cl. G09G 5/00

(52) U.S. Cl. 345/762

(57) ABSTRACT

A method for interacting with a user through a graphical user interface (GUI) for a device includes receiving a media file representative of the GUI, the media file containing a plurality of GUI streams; determining hardware resources available to the device; selecting one or more GUI streams based on the available hardware resources; rendering the GUI based on the selected one or more GUI streams; detecting a user interaction with the GUI; and refreshing the GUI in accordance with the user interaction.

The present application is related to application Ser. No. ______, entitled “SYSTEMS AND METHOD FOR PRESENTING CUSTOMIZABLE MULTIMEDIA PRESENTATIONS”, application Ser. No. ______, entitled “SYSTEMS AND METHODS FOR AUTHORING CONTENT”, and application Ser. No. ______, entitled “INTELLIGENT FABRIC”, all of which are commonly owned and are filed concurrently herewith, the contents of which are hereby incorporated by reference.

### BACKGROUND

This invention relates to authoring systems and processes supporting a graphical user interface (GUI).

The communications industry has traditionally included a number of media, including television, cable, radio, periodicals, compact disc (CDs) and digital versatile discs (DVDs). With the emergence of the Internet and wireless communications, the industry now includes Web-casters and cellular telephone service providers, among others. One over-arching goal for the communications industry is to provide relevant information upon demand by a user. For example, television, cable and radio broadcasters and Web-casters transmit entertainment, news, educational programs, and presentations such as movies, sport events, or music events that appeal to as many people as possible.

Traditionally, a single publication, video stream or sound stream is viewed or listened by a user. A number of file structures are used today to store time-based media: audio formats such as AIFF, video formats such as AVI, and streaming formats such as RealMedia. They are different at least in part because of their different focus and applicability. Some of these formats are sufficiently widely accepted, broad in their application, and relatively easy to implement, that they are used not only for content delivery but also as interchange formats such as the QuickTime file format. The QuickTime format is used today by many web sites serving time-based data; in many authoring environments, including professional ones; and on many multimedia CD ROM (e.g., DVD or CD-I) titles.

The QuickTime media layer supports the relatively efficient display and management of general multimedia data, with an emphasis on time-based material (video, audio, video and audio, motion graphics/animation, etc.). The media layer uses the QuickTime file format as the storage and interchange format for media information. The architectural capabilities of the layer are generally broader than the existing implementations, and the file format is capable of representing more information than is currently demanded by the existing QuickTime implementations. Furthermore, the QuickTime file format has structures to represent the temporal behavior of general time-based streams, a concept which covers the time-based emission of network packets, as well as the time-based local presentation of multimedia data.

Given the capabilities and flexibility provided by time-based media formats, it is desirable to provide a user interface that provides suitable functionality and flexibility for playback and/or other processing of time-based media in such formats.

Prior user interfaces for controlling the presentation of time-based media include user interfaces for the RealPlayers from RealNetworks of Seattle, Wash., user interfaces for the QuickTime MoviePlayers from Apple Computer, Inc. of Cupertino, Calif., and user interfaces for the Windows Media Players from Microsoft Corporation of Redmond, Wash. Also, there are a number of time-based media authoring systems which allow the media to be created and edited, such as Premiere from Adobe Systems of San Jose, Calif.

These prior user interfaces typically use “pop-up” or pull-down menus to display controls (e.g. controls for controlling playback) or to display a list of “favorites” or “channels” which are typically predetermined, selected media (e.g. CNN or another broadcast source which is remotely located or a locally stored media source). While these lists or menus may be an acceptable way of presenting this information, the lists or menus may not be easily alterable and the alteration operations are not intuitive. Further, these lists or menus are separate from any window presenting the media and thus do not appear to be part of such window.

In some prior user interfaces, the various controls are displayed on a border of the same window which presents the media. For example, a time bar may be displayed on a window with controls for playback on the same window. While these controls are readily visible and available to a user, a large number of controls on a window causes the window to appear complex and tends to intimidate a novice user.

Some prior user interfaces include the ability to select, for presentation, certain chapters or sections of a media. LaserDisc players typically include this capability which may be used when the media is segmented into chapters or sections. A user may be presented with a list of chapters or sections and may select a chapter or section from the list. When this list contains a large number of chapters or sections, the user may scroll through the list but the speed of scrolling is fixed at a single, predetermined rate. Thus, the user's ability to scroll through a list of chapters is limited in these prior user interfaces.

U.S. Pat. No. 6,262,724 shows a time-based media player display window for displaying, controlling, and/or otherwise processing time-based media data. The time-based media player, which is typically displayed as a window on a display of a computer or other digital processing system, includes a number of display and control functions for processing time-based media data, such as a QuickTime movie. The player window 200 may be “closed” using a close box (e.g. the user may “click” on this box to close the window by positioning a cursor on the box and depressing and releasing a button, such as a mouse's button while the cursor remains positioned on the close box). The media player includes a movie display window 202 for displaying a movie or other images associated with time-based media. In addition, a time/chapter display and control region of the media player provides functionality for displaying and/or controlling time associated with a particular time-based media file (e.g., a particular movie processed by the player). A time-based media file may be sub-indexed into “chapters” or sections which correspond to time segments of the time-based media file, and which chapters may also be titled. As such, a user may view or select a time from which, or time segment in which, to play back a time-based media file.

### SUMMARY

In one aspect, a method for interacting with a user through a graphical user interface (GUI) for a device includes receiving a media file representative of the GUI, the media file containing a plurality of GUT streams; determining hardware resources available to the device; selecting one or more GUI streams based on the available hardware resources; rendering the GUI based on the selected one or more GUT streams; detecting a user interaction with the GUI; and refreshing the GUI in accordance with the user interaction.

Implementations of the aspect may include one or more of the following. The refreshing the GUI can include receiving a second media file representative of a second GUT; and rendering the second GUI on the screen. The media file can be a time-based media file such as an MPEG file or a QuickTime file. The media file can be stored at a remote location accessible through a data processing network, or can be stored on a machine-readable medium at a local location. The media file can be sent from a remote data processing system in response to a selection of an icon on the GUI associated with the media file. The media file can be playback in response to selection of the media icon associated with the media file. The media file can be one of video data, audio data, visual data, and a combination of audio and video data. The method includes dynamically generating customized audio or video content according to the user's preferences; merging the dynamically generated customized audio or video content with the selected audio or video content; and displaying the customized audio or video content as the GUI. The method includes registering content with the server. The method also includes annotating the content with scene information. The user's behavior can be correlated with the scene information. Additional audio or video content can be correlated with an annotation such as a scene annotation. The scene information includes one or more of the following: background music, location, set props, and objects corresponding to brand names. Customized advertisement can be added to the customized video content. A presentation context descriptor and a semantic descriptor can be generated. Customized content can be provided to a viewer by archiving the viewer's behavior on a server coupled to a wide area network and collecting the viewer's preferences over time; receiving a request for a selected audio or video content; dynamically generating customized audio or video content according to the viewer's preferences; merging the dynamically generated customized audio or video content with the selected audio or video content; and displaying the customized audio or video content to the viewer.

Advantages of the invention may include one or more of the following. The system combines the advantages of traditional media with the Internet in an efficient manner so as to provide text, images, sound, and video on-demand in a simple, intuitive manner.

Other advantages and features will become apparent from the following description, including the drawings and claims.

### BRIEF DESCRIPTION OF THE DRAWINGS

FIG. 1 shows a computer-implemented process supporting interactions with a user through a graphical user interface (GUI) for a device.

FIG. 2A shows an exemplary application for supporting the GUI on top of an operating system.

FIG. 2B shows an exemplary operating system that directly supports the GUI.

FIG. 3 shows one embodiment of a fabric for supporting customizable presentations.

FIG. 4 illustrates a process for displaying content.

### DESCRIPTION

Referring now to the drawings in greater detail, there is illustrated therein structure diagrams for the customizable content transmission system and logic flow diagrams for the processes a computer system will utilize to complete various content requests or transactions. It will be understood that the program is run on a computer that is capable of communication with consumers via a network, as will be more readily understood from a study of the diagrams.

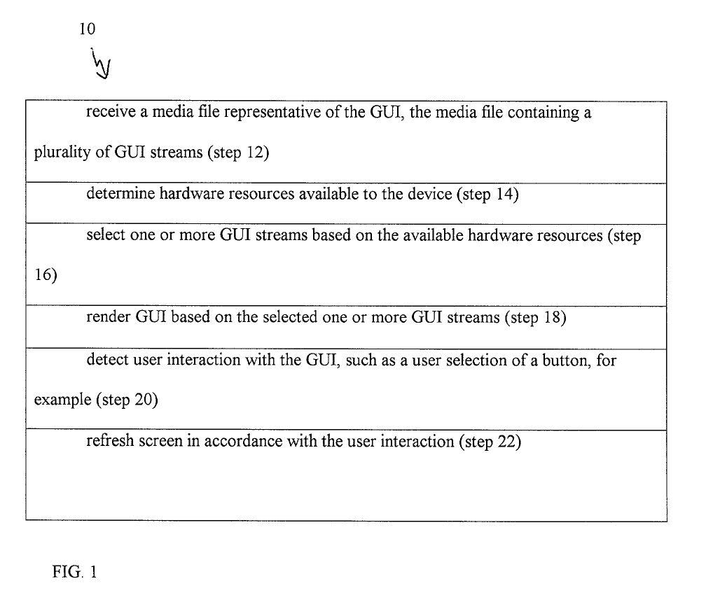

FIG. 1 shows a computer-implemented process 10 supporting interactions with a user through a graphical user interface (GUI) for a device. The device can be a desktop computer, a digital television, a handheld computer, a cellular telephone, or a suitable mobile computer, among others. The GUI is specified by a media file, such as a MPEG 4 file, for example. The media file includes a plurality of streams which are selected based on hardware characteristics of the device. For instance, a desktop computer can have a high resolution display and a large amount of buffer memory, while a handheld computer can have a small monochrome display with a small buffer memory. Depending on the hardware characteristics, one or more streams may be selected for rendering the GUI.

The media file defines compositional layout for the GUI, such as multiple windows or event specific popups and certain content meant to be displayed in a windowed presentation can make use of the popups, for example. The GUI content is arranged in regards to layout, sequence, and navigational flow. Various navigational interactivity can be specified in the GUI content, for example anchors (clickable targets), forms, alternate tracks and context menus, virtual presence (VRML-like navigation), and interactive stop mode, where playback breaks periodically pending user interaction. The file also defines and associates context menus to contextual descriptors; specify hierarchical positioning of context menu entry, description, and one or more of the following end actions (local-offline, remote, and transitional (if remote is defined)).

The process 10 includes receiving a media file representative of the GUI, the media file containing a plurality of GUI streams (step 12). Next, the method determines hardware resources available to the device (step 14) and selects one or more GUI streams based on the available hardware resources (step 16). The GUI is rendered based on the selected one or more GUI streams (step 18). After the GUI has been rendered, the method detects a user interaction with the GUI, such as a user selection of a button, for example (step 20). Based on the user selection, the method refreshes the screen in accordance with the user interaction (step 22).

The refreshing of the screen can include receiving a second media file representative of a second GUI; and rendering the second GUI on the screen. The media file can be a time-based media file such as an MPEG file or a QuickTime file. The media file can be stored at a remote location accessible through a data processing network, or can be stored on a machine-readable medium at a local location. The media file can be sent from a remote data processing system in response to a selection of an icon on the GUI associated with the media file. The media file can be playback in response to selection of the media icon associated with the media file. The media file can be one of video data, audio data, visual data, and a combination of audio and video data.

The process includes dynamically generating customized audio or video content according to the user's preferences; merging the dynamically generated customized audio or video content with the selected audio or video content; and displaying the customized audio or video content as the GUI. The method includes registering content with the server. The method also includes annotating the content with scene information. The user's behavior can be correlated with the scene information. Additional audio or video content can be correlated with an annotation such as a scene annotation. The scene information includes one or more of the following: background music, location, set props, and objects corresponding to brand names. Customized advertisement can be added to the customized video content. A presentation context descriptor and a semantic descriptor can be generated. Customized content can be provided to a viewer by archiving the viewer's behavior on a server coupled to a wide area network and collecting the viewer's preferences over time; receiving a request for a selected audio or video content; dynamically generating customized audio or video content according to the viewer's preferences; merging the dynamically generated customized audio or video content with the selected audio or video content; and displaying the customized audio or video content to the viewer.

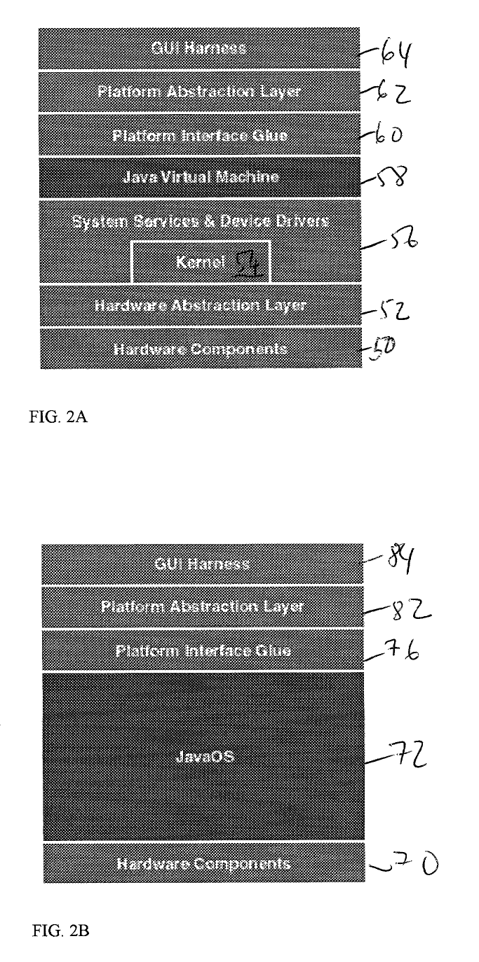

FIG. 2A shows an exemplary application for supporting the GUI on top of an operating system, while FIG. 2B shows an exemplary operating system that directly supports the GUI. In the embodiment of FIG. 2A, an application (such as a browser) runs on top of an operating system such as Windows, OsX, Linux, or Unix and renders a time-based media file such as an MPEG-4 file. The file is parsed into elements to be displayed, and the browser makes OS calls to render elements of the MPEG-4 file. Thus, if the operating system is Windows, the browser makes calls to the Windows graphics display kernel to render the parsed MPEG-4 elements.

An exemplary GUI is discussed next. In this example, the GUI is displayed by an application such as an MPEG-4 enabled browser. In the context of the MPEG specification, an elementary stream (ES) is a consecutive flow of mono-media from a single source entity to a single destination entity on the compression layer. An access unit (AU) is an individually accessible portion of data within an ES and is the smallest data entity to which timing information can be attributed. A presentation consists of a number of elementary streams representing audio, video, text, graphics, program controls and associated logic, composition information (i.e. Binary Format for Scenes), and purely descriptive data in which the application conveys presentation context descriptors (PCDs). If multiplexed, streams are demultiplexed before being passed to a decoder. Additional streams noted below are for purposes of perspective (multi-angle) for video, or language for audio and text. The following table shows each ES broken by access unit, decoded, then prepared for composition or transmission.

| | AUn | AU2 | AU1 | Decoder | Action |
|---|---|---|---|---|---|
| content | | | | | |
| elementary streams | An→ | A2→ | A1→ | video decode | scene composition |
| video base layer | An→ | A2→ | A1→ | video decode | scene composition |
| video enhancement layers | An→ | A2→ | A1→ | video decode | scene composition |
| additional video base layers | An→ | A2→ | A1→ | video decode | scene composition |
| additional video enhancement layers | An→ | A2→ | A1→ | video decode | scene composition |
| audio | An→ | A2→ | A1→ | audio decode | scene composition |
| additional audio | An→ | A2→ | A1→ | audio decode | scene composition |
| text overlay | An→ | A2→ | A1→ | text decode | scene composition |
| additional text overlays | An→ | A2→ | A1→ | text decode | scene composition |
| BiFS | An→ | A2→ | A1→ | BiFS parse | scene composition |
| context | | | | | |
| presentation context stream(s) | An→ | A2→ | A1→ | PCD parse | data transmission |
| | | | | | & context menu |
| | | | | | composition |

In this exemplary interactive presentation, a timeline indicates the progression of the scene. The content streams render the presentation proper, while presentation context descriptors reside in companion streams. Each descriptor indicates start and end time code. Pieces of context may freely overlap. As the scene plays: the current content streams are rendered, and the current context is transmitted over the network to the system. The presentation context is attributed to a particular ES, and each ES may or may not have contextual description. Presentation context of different ESs may reside in the same stream or different streams. Each presentation descriptor has a start and end flag, with a zero for both indicating a point in between. Whether or not descriptor information is repeated in each access unit corresponds to the random access characteristics of the associated content stream. For instance, predictive and bi-directional frames of MPEG video are not randomly accessible as they depend upon frames outside themselves. Therefore, in such cases, PCD info need not be repeated in such instances.

During the parsing stage of presentation context, it is determined whether the PCD is absolute, that is, its context is always active when its temporal definition is valid, or conditional, in which case it is only active upon user selection. In the latter case, the PCD refers to presentation content (not context) to jump to, enabling contextual navigation. The conditional context may also be regarded as interactive context. These PCDs include contextual information to display to the user within a context menu, which may involve alternate language translations.

While multimedia playback systems such as QuickTime provide content navigation controls, which in some cases may be customizable, this corresponds to a traditional pairing of player and content. The playback system of FIG. 2A or 2B takes a significant departure from this player-content paradigm. Instead of offering a playback GUI, a GUI harness is provided that eliminates the distinction between player and content. The GUI harness provides a general-purpose user interface mechanism as opposed to a traditional multimedia playback interface, as later is not appropriate for all types of content. Instead of providing graphical interaction primitives, such as playback and navigation controls, the GUI harness creates a flexible GUI framework that defers the definition of appropriate, content-specific interactive controls to the content itself. These definitions are constructed via a compact grammar. Pseudo code examples of this grammar are given below, such as might be seen by the user of the authoring system, as opposed to the actual binary or XML syntax to be interpreted by the GUI harness:

start presenting

stop presenting

increase temporal position by <relative time code value>

decrease temporal position <relative time code value>

start presenting for <time code value>

stop presenting for <time code value>

next jump location <time code script id>

previous jump location <time code script id>

reset temporal position

repeat

repeat last <command count>

set temporal position <time code>

execute stream <stream id of BiFS or OD stream>

The method to execute a stream is the most powerful and flexible command, because it facilitates dynamic injection of BiFS commands, such as replace or modify scene. The visual appearance and positioning of these controls are implemented as graphical content (synthetic AVOs) within a dedicated BiFS-anim stream. Just as with other video content, a mask may enable non-rectangular control objects. For example, utilizing alpha blending, a semi-transparent overlap could depict the graphical interaction primitives. Further more, an invisible or visible container primitive can be utilized to group a number of interaction primitives. Thus, the GUI harness makes the GUI a part of the content, enabling a content-specific user interface.

The GUI harness allows content behavior to utilize a rich event model, such as responding to keyboard and directional input device events. For instance, graphical interaction primitives can be contextually triggered, such as in response to an directional input device event, such as ReceiveDirectionalInputDeviceFocus, to only depict the controls in specific circumstances. This would be in contrast to depicting these controls all the time in a dedicated window. It is necessary for the GUI harness to provide this level of control as content may vary dramatically from the traditional audio-video clips utilized by existing multimedia playback systems. These graphical interaction controls might also be overridden depending on the content segment, whereas some controls might be omitted, and others added.

For instance, the content may be more information- and control-based, as well as more event driven than sequentially oriented. It's not important what types of input devices are present. The content refers to these abstractly, such as directional input device focus, whereas the device in question might turn out to be a mouse, game controller, or stylus. Instead of responding explicitly to directional input device buttons and keyboard buttons, abstract specifiers are used as well, such as directional input device button 1 and 2 to represent the equivalent of right and left mouse buttons.

Each group of graphical interaction controls might have a keyboard short cut mapped by the platform-specific implementation of the GUI harness. A specify context menu event is similarly mapped, such as to gain access to contextual information. Similarly, for non-content specific control, such as audio volume level and color control, the GUI harness will provide its own access mechanism.

FIGS. 2A and 2B illustrate the functionally layering of the GUI Harness subsystem. In FIG. 2A, exemplary operating system (OS) communication layers include a hardware abstraction layer 52 that rests above the hardware 50. A kernel 54 runs within a system services and device layer 56. A virtual machine (VM) layer 58 such as the Java VM layer runs on top of the layer 56. Further, platform interface glue layer 60 resides above the VM layer 58, and a platform abstraction layer 62 resides between the glue layer 60 and the GUI harness 64. The platform abstraction layer 62 provides an interface to the event model and the streamable GUI model consisting of the generation of graphical interactive primitives.

The OS appears as special, privileged interactive content to the GUI harness, enabling its own look-and-feel and behavior to be maintained. Visual items utilized by the OS GUI can be dynamically prepared just as they would in the traditional, native circumstance. Input device events are trapped by the GUI harness. The harness may process these events on behalf of the content's abstracted event specification, subject to Operating System overrides. The interactivity provides a thin wrapping of the native OS event model. While traditional content might employ static navigation, the OS presentation employs a dynamic event model. For instance, at boot up, as the harness is loaded, the OS may query desktop objects then dynamically stream a visual representation to the harness, including interactive information that will map and trigger events to be caught and interpreted naturally to the host OS. This could be a JPEG, for instance, as well as an animated object represented by the VRML-derived syntax of BiFS.

In any event, the OS communicates with the harness via content streams, such as to display message boxes. These streams will contain BiFS information concerning interactive objects, such as a dialog box tab. The OS would provide hooks for its UI primitives, so that it may trap its GUI API requests and translate them into streamable content to the harness. Interactions with operating system AVO objects, which may overlay that of independent content in certain instances, are trapped by the GUT harness and relayed to the OS to perform its implementation-specific event processing.

Next, an example of GUI Harness running as an OS application is discussed. In this example, a user is running an operating system such as Windows, OS X, Linux, Unix, Windows CE, or PalmOS, and wishes to run an ASP-hosted word processing application via the GUI Harness. Document files may be located on the local device or on remote storage. The user runs the GUI Harness application. Within this application, the user logs into the ASP network for authentication and authorization purposes, and is admitted. The network could either be selected via a query of available services, or specified manually by the user. LDAP is likely the enabling architecture behind service lookup and access.

The user selects a word processing application. Application information pertaining to licensing, including pricing and billing information is always available through the harness application, and likely is accessible in the directory in which the user browses for available applications. If the user does not have rights to the application, they must register and fulfill any initial licensing requirements before being granted access.

The user requests initiates an ASP session, and application data is streamed to the client. The typical type of ASP application will be the thin client variety, in which the server conducts the bulk of application processing, but fatter clients are possible. In the instance of a fatter client, executable code may be acquired from an elementary stream, or may already reside on storage accessible to the device, such as a hard drive. The distinction of whether code is run remotely or locally is gracefully handed through the Application Definable Event Model supported by the [iSC] GUI harness. This distinction can be mixed and matched for an ASP session. Local code is associated to GUI elements via ids, so that the harness may route processing. This also makes caching possible, such that remote routines may be cached locally for some period of time through the harness. Each interactive primitive is articulated via BiFS data and must carry a unique identifier When the user interacts with the GUI element via an input device, the interaction is relayed via an event, consisting of the object's unique ID and event specific data. When local code is running, an application proxy runs in the background to receive messages. If the event is handled by a local routine, the message is sent to the application proxy, other wise, it is sent over the wire. The harness treats both cases identically.

Application data may involve executable code, such as java routines, which is loaded into the memory space of the application proxy.

Application data may involve audio, visual, and data streams (including BiFS information) pertaining to GUI resources. Visual of course includes stills, natural video, and synthetic video. While a word processing application primarily displays a text window, text and a cursor, it may have combo boxes and menu entries as well. Let's take the example of a combo box. The combo box exists as an element within the BIFS scene, and is overlaid with an additional text object, such as corresponding to a font name, also a part of the scene composition. The combo box has a selection arrow, which when triggered via an input device, displays a window of font names, and a scroll bar. This window is already part of the BiFS scene, but is hidden until triggered. The text in the window is accessed as a still image, and an additional scene element is the highlight visual object.

For elements that include textual input, local streaming is specified for the text window within the scene. The stream passes through the Delivery Multimedia Interface Framework, as discussed in the MPEG-4 Systems specification. The GUI harness renders the text as a still, which serves as an off-screen double buffer, and is streamed, being displayed with the next access unit.

The standard MPEG-4 mechanism then operates to deliver of streaming data. The synchronized delivery of streaming information from source to destination, exploiting different QoS as available from the network, is specified in terms of the aforementioned synchronization layer and a delivery layer containing a two-layer multiplexer. In MPEG4, a “TransMux” (Transport Multiplexing) layer models the layer that offers transport services matching the requested QoS. Only the interface to this layer is specified by MPEG-4 while the concrete mapping of the data packets and control signaling must be done in collaboration with the bodies that have jurisdiction over the respective transport protocol. Any suitable existing transport protocol stack such as (RTP)/UDP/IP, (AAL5)/ATM, or MPEG2's Transport Stream over a suitable link layer may become a specific TransMux instance. The choice is left to the end user/service provider, and allows MPEG-4 to be used in a wide variety of operation environments.

With regard to the MPEG-4 System Layer Model, it is possible to:

identify access units, transport timestamps and clock reference information and identify data loss.

optionally interleave data from different elementary streams into FlexMux streams convey control information to:

indicate the required QoS for each elementary stream and FlexMux stream;

translate such QoS requirements into actual network resources;

associate elementary streams to media objects

convey the mapping of elementary streams to FlexMux and TransMux channels

Parts of the control functionalities are available only in conjunction with a transport control entity like the DMIF framework.

In general, the user observes a scene that is composed following the design of the scene's author. Depending on the degree of freedom allowed by the author, however, the user has the possibility to interact with the scene. Operations a user may be allowed to perform include:

change the viewing/listening point of the scene, e.g. by navigation through a scene;

drag objects in the scene to a different position;

trigger a cascade of events by clicking on a specific object, e.g. starting or stopping a video stream;

select the desired language when multiple language tracks are available;

More complex kinds of behavior can also be triggered, e.g. a virtual phone rings, the user answers and a communication link is established.

Returning now to the example, an Application Definable Event Model enables communication between the user and the application through the user interface hosted within the GUI harness. The harness utilizes metadata relating to the BiFS elements to indicate events and event context. For instance, when the user selects a different font from the combo box, the harness has the scene information to update the combo box. The event information must still be passed to the application, to indicate the new font selection, which will result in streaming data on behalf of the main text window object, which is likely to be processed locally, and updated with a dynamically generated stream, which passes through DMIF.

The harness then, when running as an OS application, renders or processes elementary stream data, utilizing BiFS information. Whether something is rendered, such as video, or processed such as event information, a CODEC achieves this. The CODEC may result in information being passed to the harness to be relayed elsewhere, thus, corresponding to a back channel. The harness, via its DMIF implementation, knows how to talk to a remote application or a local application. A chief feature of the harness is the dynamic creation of data streams. In the case that the harness is implemented in java, this necessitates a Java Virtual Machine. In any event, the harness runs as a typical computer application

FIG. 2B shows a second embodiment of a GUI harness 84 embedded in an operating system 72 that runs above hardware 70. The OS 72 can be JavaOS, for example. Similar to FIG. 2A, a platform interface glue layer 76 resides above the OS layer 72, and a platform abstraction layer 82 resides between the glue layer 76 and the GUI harness 84.

Next, an example of a GUI Harness running as the OS GUI is discussed. In this example, the user is operating a device whose GUI consists of the GUI Harness application. An OS GUI, in some cases referred to as a desktop, is essentially a privileged application, through which the user may interact with the OS, and other applications may be run and displayed. To enable this, whatever abstraction layer an operation employs to interface with its GUI, must interface with the Platform Abstraction Layer of the harness. This implementation corresponds to the Platform Interface Glue. Together they represent the harness' operating system interface.

Much of the implementation specific code corresponds to drawing code and networking code. In regards to a java implementation of the harness, the core code is already implemented by virtue of a JVM or JavaOS.

The OS GUI itself is authored as elementary streams corresponding to graphic representations. These streams are articulated by scene compositions through the BiFS layer. An icon for example, is a still image object the user can interact with via the scene composition. As an object is operated on, the harness relays its id and any event specific information. For instance, a folder icon being double clicked, could corresponding to a graphical interaction of the icon and the passing of the message to the OS, which would correspond to BIFS commands to update the scene, and display the folders contents. Instead of updating the display device natively, the harness' drawing API would be used to create a dynamic stream and route it through its DMIF implementation.

Outside of this, the harness as an OS GUI works in the same manner as an ordinary application hosted on a given operating system. All rendering passes through a dynamic stream creation interface, which is then passed to DMIF, after which it is displayed as BiFS-enhanced audio-visual content. All processed information streams are passed from the CODEC to DMIF, and then from DMIF to the operating system via a backchannel.

Input controls are streams as animated AVO objects to the harness. This is critical when hosting program content. This even accommodates features such as drag-and-drop, in which the size and/or position of the AVO object is manipulated by the user. These objects may define audio feedback to the user.

Because streams may be spatially positioned and overlayed in regards to z-ordering, as well as supplying a visibility mask to produce non-rectangular shape, the notion of window can be quite conceptual. The specification of multiple windows may be used to combine different types of content within a presentation, for example. When multiple windows are utilized, the player is faced with integrating multiple presentations, which may contain regularly time varying content, such as audio and/or video, as well as non-temporally driven content, such as input forms. The platform-specific implementation may handle the windows as it may, such as by only displaying one window at a time, or displaying the windows on the same viewing device or across multiple viewing devices.

Executable code may be conveyed in elementary streams. Thus, the program may be loaded in RAM as normal, including on demand. The OS executes code as normal, but short circuits its native display mechanisms by conveying equivalent display as content to the GUI. This method supports traditional code delivery and execution, whether platform-specific C code, or portable java code.

The implementation GUI harness can provide a much more radical means of program development and execution. A program's user interface may be authored as content, in which event-specific interaction with the UI is communicated to the executable module, such as a remote server hosted program on an ASP platform. Here, the user interface is streamed as content to be handled on wide ranging device types. The use of alternate streams could provide alternate representations, such as text-based, simple 2D-based, and so forth.

The above GUI can be automatically customized to the user's preferences. The automatic customization is done by detecting relationships among a user viewing content in particular context(s). The user interacts with a viewing system through the GUI described above. Upon log-in, a default GUI is treamed and played to the user. The user can view the default stream, or can interact with the content by navigating the GUI, for example by clicking an icon or a button. The user interest exhibited implicitly in his or her selection and request is captured as the context. The actions taken by the user through the user interface is captured, and over time, the behavior of a particular user can be predicted based on the context. Thus, the user can be presented with additional information associated with a particular program. For example, as the user is browsing through the GUI, he or she may wish to obtain more information on a topic. The captured context is used to customize information to the viewer in real time. The combination of content and context is used to provide customized content, including advertising, to viewers.

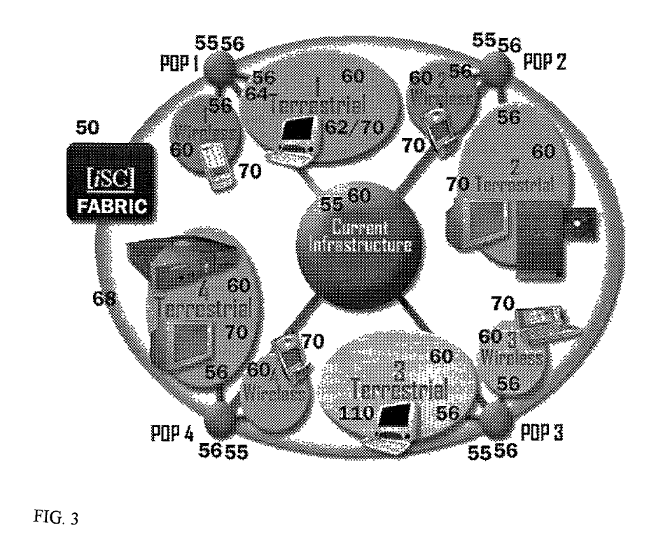

FIG. 3 shows an exemplary system that captures the context. The system also stores content and streams the content, as modified in real-time by the context, to the user on-demand. The system includes a switching fabric 50 connecting a plurality of local networks 60. The switching fabric 50 provides an interconnection architecture which uses multiple stages of switches to route transactions between a source address and a destination address of a data communications network. The switching fabric 50 includes multiple switching devices and is scalable because each of the switching devices of the fabric 50 includes a plurality of network ports and the number of switching devices of the fabric 50 may be increased to increase the number of local network 60 connections for the switch. The fabric 50 includes all networks which subscribe and are connected to each other and includes wireless networks, cable television networks, WAN's such as Exodus, Quest, DBN.

Computers 62 are connected to a network hub 64 that is connected to a switch 56, which can be an Asynchronous Transfer Mode (ATM) switch, for example. Network hub 64 functions to interface an ATM network to a non-ATM network, such as an Ethernet LAN, for example. Computer 62 is also directly connected to ATM switch 66. Two ATM switches are connected to WAN 68. The WAN 68 can communicate with a switching fabric such as a cross-bar network or a Bayan network, among others. The switching fabric is the combination of hardware and software that moves data coming in to a network node out by the correct port (door) to the next node in the network.

Connected to the local networks 60 are viewing terminals 70 and one or more local servers 62. Each server 62 includes a content database that can be customized and streamed on-demand to the user. Its central repository stores information about content assets, content pages, content structure, links, and user profiles, for example. Each local server 62 also captures usage information for each user, and based on data gathered over a period, can predict user interests based on historical usage information. Based on the predicted user interests and the content stored in the server, the server can customize the content to the user interest. The local server 62 can be a scalable compute farm to handle increases in processing load. After customizing content, the local server 62 communicates the customized content to the requesting viewing terminal 70.

The viewing terminals 70 can be a personal computer (PC), a television (TV) connected to a set-top box, a TV connected to a DVD player, a PC-TV, a wireless handheld computer or a cellular telephone. However, the system is not limited to any particular hardware configuration and will have increased utility as new combinations of computers, storage media, wireless transceivers and television systems are developed. In the following any of the above will sometimes be referred to as a “viewing terminal”. The program to be displayed may be transmitted as an analog signal, for example according to the NTSC standard utilized in the United States, or as a digital signal modulated onto an analog carrier, or as a digital stream sent over the Internet, or digital data stored on a DVD. The signals may be received over the Internet, cable, or wireless transmission such as TV, satellite or cellular transmissions.

In one embodiment, a viewing terminal 70 includes a processor that may be used solely to run a browser GUI and associated software, or the processor may be configured to run other applications, such as word processing, graphics, or the like. The viewing terminal's display can be used as both a television screen and a computer monitor. The terminal will include a number of input devices, such as a keyboard, a mouse and a remote control device, similar to the one described above. However, these input devices may be combined into a single device that inputs commands with keys, a trackball, pointing device, scrolling mechanism, voice activation or a combination thereof.

The terminal 70 can include a DVD player that is adapted to receive an enhanced DVD that, in combination with the local server 62, provides a custom rendering based on the content 2 and context 3. Desired content can be stored on a disc such as DVD and can be accessed, downloaded, and/or automatically upgraded, for example, via downloading from a satellite, transmission through the internet or other on-line service, or transmission through another land line such as coax cable, telephone line, optical fiber, or wireless technology.

An input device can be used to control the terminal and can be a remote control, keyboard, mouse, a voice activated interface or the like. The terminal includes a video capture card connected to either live video, baseband video, or cable. The video capture card digitizes a video image and displays the video image in a window on the monitor. The terminal is also connected to a local server 62 over the Internet using a modem. The modem can be a 56K modem, a cable modem, or a DSL modem. Through the modem, the user connects to a suitable Internet service provider (ISP), which in turn is connected to the backbone of the network 60 such as the Internet, typically via a T1 or a T3 line. The ISP communicates with the viewing terminals 70 using a protocol such as point to point protocol (PPP) or a serial line Internet protocol (SLIP) 100 over one or more media or telephone network, including landline, wireless line, or a combination thereof On the terminal side, a similar PPP or SLIP layer is provided to communicate with the ISP. Further, a PPP or SLIP client layer communicates with the PPP or SLIP layer. Finally, a network aware application such as a browser receives and formats the data received over the Internet in a manner suitable for the user. As discussed in more detail below, the computers communicate using the functionality provided by Hypertext Transfer Protocol (HTTP). The World Wide Web (WWW) or simply the “Web” includes all the servers adhering to this standard which are accessible to clients via Uniform Resource Locators (URL's). For example, communication can be provided over a communication medium. In some embodiments, the client and server may be coupled via Serial Line Internet Protocol (SLIP) or TCP/IP connections for high-capacity communication.

Active within the viewing terminal is a user interface provided by the browser that establishes the connection with the server 62 and allows the user to access information. In one embodiment, the user interface is a GUI that supports Moving Picture Experts Group-4 (MPEG-4), a standard used for coding audio-visual information (e.g., movies, video, music) in a digital compressed format. The major advantage of MPEG compared to other video and audio coding formats is that MPEG files are much smaller for the same quality using high quality compression techniques. In another embodiment, the GUI can be embedded in the operating system such as the Java operating system. More details on the GUI are disclosed in the copending application entitled “SYSTEMS AND METHODS FOR DISPLAYING A GRAPHICAL USER INTERFACE”, the content of which is incorporated by reference.

In another embodiment, the terminal 70 is an intelligent entertainment unit that plays DVD. The terminal 70 monitors usage pattern entered through the browser and updates the local server 62 with user context data. In response, the local server 62 can modify one or more objects stored on the DVD, and the updated or new objects can be downloaded from a satellite, transmitted through the internet or other on-line service, or transmitted through another land line such as coax cable, telephone line, optical fiber, or wireless technology back to the terminal. The terminal 70 in turn renders the new or updated object along with the other objects on the DVD to provide on-the-fly customization of a desired user view.

The system handles MPEG (Moving Picture Experts Group) streams between a server and one or more clients using the switches. (This is accurate only if we consider an entire WAN such as one of Nokias Wireless Networks as a “Client”. In this context, the client is the terminal that actually delivers the final rendered presentation.

The server broadcasts channels or addresses which contain streams. These channels can be accessed by a terminal, which is a member of a WAN, using IP protocol. The switch, which sits at the gateway for a given WAN, allocates bandwidth to receive the channel requested. The initial Channel contains BiFS Layer Information, which the Switch can parse, process DMIF to determine the hardware profile for its network and determine the addresses for the AVO's needed to complete the defined presentation. The Switch passes the AVO's and the BiFS Layer information to a Multiplexor for final compilation prior to broadcast on to the WAN.

As specified by the MPEG-4 standard, the data streams (elementary streams, ES) that result from the coding process can be transmitted or stored separately, and need only to be composed so as to create the actual multimedia presentation at the receiver side. In MPEG-4, relationships between the audio-visual components that constitute a scene are described at two main levels. The Binary Format for Scenes (BIFS) describes the spatio-temporal arrangements of the objects in the scene. Viewers may have the possibility of interacting with the objects, e.g. by rearranging them on the scene or by changing their own point of view in a 3D virtual environment. The scene description provides a rich set of nodes for 2-D and 3-D composition operators and graphics primitives. At a lower level, Object Descriptors (ODs) define the relationship between the Elementary Streams pertinent to each object (e.g. the audio and the video stream of a participant to a videoconference) ODs also provide additional information such as the URL needed to access the Elementary Steams, the characteristics of the decoders needed to parse them, intellectual property and others.

Media objects may need streaming data, which is conveyed in one or more elementary streams. An object descriptor identifies all streams associated to one media object. This allows handling hierarchically encoded data as well as the association of meta-information about the content (called ‘object content information’) and the intellectual property rights associated with it. Each stream itself is characterized by a set of descriptors for configuration information, e.g., to determine the required decoder resources and the precision of encoded timing information. Furthermore the descriptors may carry hints to the Quality of Service (QOS) it requests for transmission (e.g., maximum bit rate, bit error rate, priority, etc.) Synchronization of elementary streams is achieved through time stamping of individual access units within elementary streams. The synchronization layer manages the identification of such access units and the time stamping. Independent of the media type, this layer allows identification of the type of access unit (e.g., video or audio frames, scene description commands) in elementary streams, recovery of the media object's or scene description's time base, and it enables synchronization among them. The syntax of this layer is configurable in a large number of ways, allowing use in a broad spectrum of systems.

The synchronized delivery of streaming information from source to destination, exploiting different QoS as available from the network, is specified in terms of the synchronization layer and a delivery layer containing a two-layer multiplexer. The first multiplexing layer is managed according to the DMIF specification, part 6 of the MPEG-4 standard. (DMIF stands for Delivery Multimedia Integration Framework) This multiplex may be embodied by the MPEG-defined FlexMux tool, which allows grouping of Elementary Streams (ESs) with a low multiplexing overhead. Multiplexing at this layer may be used, for example, to group ES with similar QoS requirements, reduce the number of network connections or the end to end delay. The “TransMux” (Transport Multiplexing) layer models the layer that offers transport services matching the requested QoS.

Content can be broadcast allowing a system to access a channel, which contains the raw BiFS Layer. The BiFS Layer contains the necessary DMIF information needed to determine the configuration of the content. This can be looked at as a series of criteria filters, which address the relationships defined in the BiFS Layer for AVO relationships and priority.

DMIF and BiFS determine the capabilities of the device accessing the channel where the application resides, which can then determine the distribution of processing power between the server and the terminal device. Intelligence, built in to the fabric, will allow the entire network to utilize predictive analysis to configure itself to deliver QOS. The switch 16 can monitor data flow to ensure no corruption happens. The switch also parses the ODs and the BiFSs to regulate which elements it passes to the multiplexer and which it does not. This will be determined based on the type of network the switch sits as a gate to and the DMIF information. This “Content Conformation” by the switch happens at gateways to a given WAN such as a Nokia 144k 3-G Wireless Network. These gateways send the multiplexed data to switches at its respective POP's where the database is installed for customized content interaction and “Rules Driven” Function Execution during broadcast of the content.

When content is authored, the BiFS can contain interaction rules that query a field in a database. The field can contain scripts that execute a series of “Rules Driven” (If/Then Statements), for example: If user “X” fits “Profile A” then access Channel 223 for AVO 4. This rules driven system can customize a particular object, for instance, customizing a generic can to reflect a Coke can, in a given scene.

Each POP send its current load status and QOS configuration to the gateway hub where Predictive Analysis is performed to handle load balancing of data streams and processor assignment to deliver consistent QOS for the entire network on the fly. The result is that content defines the configuration of the network once its BiFS Layer is parsed and checked against the available DMIF Configuration and network status. The switch also periodically takes snapshots of traffic and processor usage. The information is archived and the latest information is correlated with previously archived data for usage patterns that are used to predict the configuration of the network to provide optimum QOS. Thus, the network is constantly re-configuring itself The content on the fabric can be categorized in to two high level groups:

1. A/V (Audio and Video): Programs can be created which contain AVO's (Audio Video Objects), their relationships and behaviors (Defined in the BiFS Layer) as well as DMIF (Distributed Multimedia Interface Framework) for optimization of the content on various platforms. Content can be broadcast in an “Unmultiplexed” fashion by allowing the GLUI to access a channel which contains the Raw BiFS Layer. The BiFS Layer will contain the necessary DMIF information needed to determine the configuration of the content. This can be looked at as a series of criteria filters, which address the relationships defined in the BiFS Layer for AVO relationships and priority. In one exemplary application, a person using a connected wireless PDA, on a 144 k, 3 -G WAN, can request access to a given channel, for instance channel 345. The request transmits from the PDA over the wireless network and channel 345 is accessed. Channel 345 contains BiFS Layer information regarding a specific show. Within the BiFS Layer is the DMIF information, which says . . . If this content is being played on a PDA with access speed of 144 k then access AVO 1, 3, 6, 13 and 22. The channels where these AVO's may be defined can be contained in the BiFS Layer of can be extensible by having the BiFS layer access a field on a related RRUE database which supports the content. This will allow for the elements of a program to be modified over time. A practical example of this systems application is as follows: a broadcaster transmitting content with a generic bottle can receive advertisement money from Coke another from Pepsi. The Actual label on the bottle will represent the advertiser when a viewer from a given area watches the content. The database can contain and command rules for far more complex behavior. If/Then Statements relative to the users profile and interaction with the content can produce customized experiences for each individual viewer on the fly.

2. Applications (ASP): Applications running on fabric represent the other type of Content. These applications can be developed to run on the servers and broadcast their interface to the GLUI of the connected devices. The impact of being able to write an application such as a word processor than can send its interface, in for example, compressed JPEG format to the end users terminal device such as a wireless connected PDA.

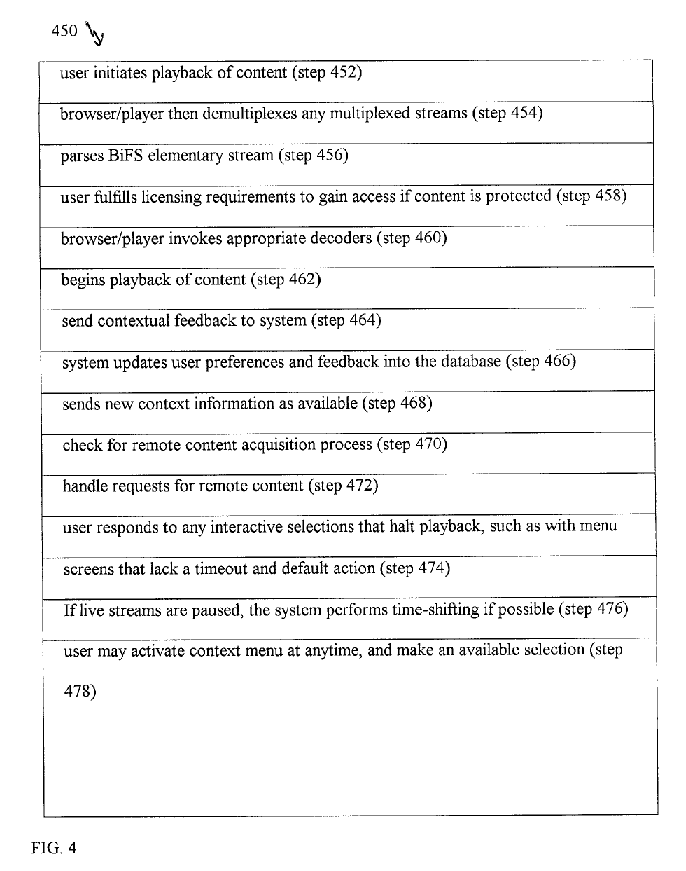

FIG. 4 illustrates a process 450 for displaying data either on the GUI on an application such as a browser. First, a user initiates playback of content (step 452). The GUI/browser/player then demultiplexes any multiplexed streams (step 454) and parses a BiFS elementary stream (step 456). The user then fulfill any necessary licensing requirements to gain access if content is protected, this could be ongoing in the event of new content acquisitions (step 458). Next, the browser/player invokes appropriate decoders (step 460) and begins playback of content (step 462). The GUI/browser/player continues to send contextual feedback to system (step 464), and the system updates user preferences and feedback into the database (step 466). The system captures transport operations such as fast forward and rewind, generate context information, as they are an aspect of how users interact with the title; for instance, what segments users tend to skip, and which users tend to watch repeatedly, are of interest to the system. In one embodiment, the system logs the user and stores the contextual feedback, applying any relative weights assigned in the Semantic Map, and utilizing the Semantic Relationships table for indirect assignments, an intermediate table should be employed for optimized resolution; the assignment of relative weights is reflected in the active user state information. Next, system sends new context information as available, such as new context menu items (step 468). The system may utilize rules-based logic, such as for sending customer focused advertisements, unless there are multiple windows, this would tend to occur during the remote content acquisition process (step 470). The system then handles requests for remote content (step 472).

After viewing the content, the user responds to any interactive selections that halt playback, such as with menu screens that lack a timeout and default action (step 474). If live streams are paused, the system performs time-shifting if possible (step 476). The user may activate context menu at anytime, and make an available selection (step 478). The selection may be subject to parental control specified in the configuration of the player or browser.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method for interacting with a user through a graphical user interface (GUI) for a device, comprising:
receiving a media file representative of the GUI, the media file containing a plurality of GUI streams;
determining hardware resources available to the device;
selecting one or more GUI streams based on the available hardware resources;
rendering the GUI based on the selected one or more GUI streams;
detecting a user interaction with the GUI; and
refreshing the GUI in accordance with the user interaction.

2. The method of claim 1, wherein refreshing the GUI further comprises:
receiving a second media file representative of a second GUI; and
rendering the second GUI.

3. The method of claim 1, wherein the media file is a time-based media file.

4. The method of claim 3, wherein the time-based media file comprises an MPEG file or a QuickTime file.

5. The method of claim 1, further comprising storing the media file at a remote location accessible through a data processing network.

6. The method of claim 5, further comprising storing the media file on a machine-readable medium at a local location.

7. The method of claim 1, further comprising receiving the media file from a remote data processing system in response to a selection of an icon on the GUI associated with the media file.

8. The method of claim 1, further comprising storing the media file for playback in response to selection of the media icon associated with the media file.

9. The method of claim 1, wherein the media file comprises one of video data, audio data, visual data, and a combination of audio and video data.

10. The method of claim 1, further comprising:
a. dynamically generating customized audio or video content according to the user's preferences;
b. merging the dynamically generated customized audio or video content with the selected audio or video content; and
c. displaying the customized audio or video content as the GUI.

11. The method of claim 10, further comprising registering content with the server.

12. The method of claim 11, further comprising annotating the content with scene information.

13. The method of claim 12, wherein the user's behavior is correlated with the scene information.

14. The method of claim 13, further comprising correlating additional audio

15. or video content with an annotation.

16. The method of claim 13, further comprising correlating additional audio

17. or video content with scene information.

18. The method of claim 12, wherein the scene information includes one or more of the following: background music, location, set props, and objects corresponding to brand names.

19. The method of claim 12, further comprising adding customized advertisement to the customized video content.

20. The method of claim 1, further comprising generating a presentation context descriptor and a semantic descriptor.
